(19) United States
(12) Patent Application Publication
(10) Pub. No.: US 2007/0184266 A1
(43) Pub. Date: Aug. 9, 2007

(54) Hydrosoluble polymers exhibiting improved solubility characteristics, the production and use thereof

(76) Inventors: Norbert Steiner, Alzenau (DE); Gregor Herth, Krefeld (DE); Klaus Zimmermann, Rodenbach (DE); Harald Jakob, Hasselroth (DE); Ralph Overdick, Hofheim (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/552,512

(22) PCT Filed: Apr. 6, 2004
(86) PCT No.: PCT/EP04/03610

§ 371 Date: Jul. 31, 2006

(30) Foreign Application Priority Data
Apr. 9, 2003 (DE) 103-16-476

(51) Int. Cl. B32B 5/16

(52) U.S. Cl. 428/403; 427/213

(57) ABSTRACT

The invention relates to hydrosoluble polymers exhibiting improved solubility characteristics, the production and use thereof. The inventive polymers can be of natural or synthetic nature and are provided with a water glass-containing coating. They are used, for example for water and wastewater treatment.

The present invention relates to synthetic and natural water-soluble polymers with a coating of water glass, and to the synthesis and use of same. By virtue of the coating, the polymers exhibit greatly improved dissolution behavior in water and aqueous solutions.

Water-soluble polymers frequently exhibit poor dissolution behavior, especially when they have a high molecular weight. In practice, therefore, additional time and effort are always needed for preparation of usable solutions. Because of this problem, the use of special dissolution devices such as those described in German Patent 4402547 is frequently necessary.

Polyacrylamides represent a major group among the water-soluble polymers. Acrylamide polymers in the form of their anionic, cationic or amphoteric copolymers are used in many areas of solid-liquid separation. Besides communal clarifying installations and the paper industry, the mining industry is a further important user of flocculation auxiliaries.

Dispersion of the solid acrylamide polymers in water is greatly impeded by their tendency to form clumps or agglomerates after contact with water. Immediately after introduction of the polymer powder into water, clumps of solid polymer are formed by encapsulation of undissolved solids in an outer shell of the water-wetted polymer, thus delaying the penetration of further water into the agglomerate.

In many mining applications, for example, large quantities of flocculation auxiliaries must be dissolved under difficult conditions, such as low water temperatures, sometimes below 15° C., and inadequate dissolution systems with inadequate stirring machines. In many cases, polyacrylamides are also introduced into the dissolution vessel without stirring, and stirring is begun only later. As a result, aggregates that can no longer be broken up are frequently formed. These gelled agglomerates lead on the one hand to reduced effectiveness and on the other hand to a processing problem in the form of clogs in the dissolution and proportioning systems.

Some attempts to improve the dissolution behavior of polyacrylamides in water are described in the prior art.

From WO 92/20727 there are known coated, water-soluble or water-swellable polymer particles. Crystalline substances such as sodium sulfate or sodium carbonate are used as coating material, preferably applied by spraying saturated salt solutions onto the polymer particles in mixtures. The proportion of crystalline coating material is very high and can be as much as 55 wt %. Proportions of 10 to 30 wt % are shown in the examples. The coated particles exhibit improved dispersion capability in aqueous solutions, but the dissolution behavior under difficult conditions is still unsatisfactory. Furthermore, the large quantities of coating agent represent an undesired weight ballast.

From German Unexamined Applications 2607757 and 2612101 there are known acrylamide polymers that do not clump upon dissolution in water and that are formed by treating the acrylamide powder with up to 30 wt % of hydroxy acids or amino acids. The treatment takes place in the presence of organic solvents that are miscible with water.

The object of the present invention was therefore to overcome the disadvantages of the prior art and to modify water-soluble polymers with the smallest possible quantities of a modifying agent in such a way that they can be reliably dissolved even under the difficult conditions described hereinabove. A further object of the invention is to provide, for modification of water-soluble polymers, a method that can be performed without use of environmentally polluting organic solvents and that leads to a substantially closed surface coating of the polymer particles.

This object is achieved according to the invention by providing the water-soluble polymer particles with a coating of water glass. Such coated polymer particles exhibit excellent dispersion and dissolution behavior, which in particular is still the case even under difficult dissolution conditions. Clumping of the polymer particles in the aqueous solution is largely suppressed.

Furthermore, it was a complete surprise to discover that, during use of water glass with much smaller quantities of coating, better dissolution characteristics were achieved in comparison with prior art products; in particular, an increasing proportion of silicate in the water glasses permitted particularly effective coatings.

The proportion of the coating in the coated polymer can vary within wide limits, usually amounting to 0.1 to 25 wt %, preferably 0.5 to 10 wt % and particularly preferably 1 to 5 wt %.

The water glasses to be used according to the invention are alkali metal silicates, which have a glassy or in other words amorphous condition and are characterized by a molar composition of nSiO₂×Me₂O, where Me denotes the corresponding alkali metal moiety and the values of n are greater than 1. The molecular ratio of SiO₂ to Me₂O is also known as the modulus. According to the invention, water glasses with a modulus M>1, preferably with a modulus M≧2 and particularly preferably M≧3 are used. As regards the alkali metal moieties, there are usually used water glasses containing sodium and potassium, preferably sodium.

By coating water-soluble polymers, especially homopolymers and copolymers of polyacrylamide with water glass, there is obtained, especially with a water glass having a modulus≧3, a very homogeneous coating layer that has a glassy, fused appearance and imparts excellent dissolution behavior to the polymers under difficult conditions.

In a further embodiment of the invention, the water glasses are combined with at least one further inorganic and/or organic water-soluble compound. As examples of further water-soluble compounds there are used alkali metal salts from the series comprising carbonates, sulfates, halides, mono-, di- and triphosphates, borates, phosphonates, carboxylates, nitrates, sulfonates, acetates, hydroxycarboxylic acids and amino acids or mixtures thereof. Preferably there are used sodium carbonate, sodium sulfate, trisodium phosphate and sodium metaborate. The proportion of the further inorganic or organic water-soluble compound in the [. . . ] amounts to 1 to 99 wt %, especially 2 to 70 wt % and particularly preferably 5 to 50 wt %.

In a further embodiment of the invention, the surface coating of the polymer particles is built up from at least two layers, the first layer being composed of this further water-soluble inorganic and/or organic compound. The second, outer layer is composed of water glass or of one of the aforesaid mixtures of water glass and a further inorganic and/or organic compound.

To optimize the flow properties of the coated polymer powders, there can be added what are known as free-flow auxiliaries or antiblocking agents, which prevent blocking of the inventive polymer particles in the dry condition during storage and transportation. Organic and inorganic substances such as bentonites, zeolites, aerosils and active charcoals are suitable as auxiliaries. The proportion of these auxiliaries amounts to 0.1 to 10 wt %, preferably 0.5 to 5 wt % relative to the polymer powder.

Water-soluble polymers within the meaning of the invention are of both synthetic and natural type.

As examples of natural polymers there can be mentioned the water-soluble polysaccharides of cellulose, starch, galactomannane, chitosan and xanthan, especially the water-soluble derivatives thereof. Derivatization can be achieved by physical methods and/or chemical methods, such as etherification and esterification reagents, and it leads to neutral, anionic and cationic products. As chemical derivatives there can be considered in particular those of the carboxyl, carboxyalkyl and hydroxyalkyl types as well as mixtures thereof. As examples, there are cited the compounds carboxymethylcellulose, methylcellulose, hydroxypropylcellulose, carboxymethyl starch, oxidized starches, swelling starches and cationic starch ethers.

Synthetic water-soluble polymers within the meaning of the present invention are formed from water-soluble, ethylenically unsaturated monomers by radical polymerization. Depending on monomer composition, it is possible in this way to obtain nonionic, cationic, anionic or amphoteric polymers.

Polyacrylamides represent a preferred group among the synthetic water-soluble polymers to be used according to the invention. By polyacrylamide within the meaning of the present patent there is understood a water-soluble homopolymer or copolymer that contains acrylamide as a monomer constituent.

As anionic comonomers for polyacrylamides there can be considered in particular (meth)acrylic acid, vinylsulfonic acid, acrylamidomethylpropanesulfonic acid, (meth)allylsulfonic acid, maleic acid, fumaric acid and itaconic acid. All of the cited acids can be polymerized as free acids, as salts or as mixtures thereof. Neutralization of the monomers can be achieved with alkali metal hydroxides, alkaline earth metal hydroxides, amines, aminoalcohols and/or ammonia. Furthermore, every other base that forms a water-soluble acid with the acid can be used, and even mixed neutralization with different bases is possible. Preferred anionic comonomers are acrylic acid, vinylsulfonic acid and acrylamidomethylpropanesulfonic acid and/or the salts thereof.

As nonionic comonomers for the polyacrylamides there can be considered monomers having complete or limited water solubility, such as (meth)acrylonitrile, N,N-dimethylacrylamide, vinylpyridine, vinyl acetate, methacrylamide, hydroxy-group-containing esters of polymerizable acids, the hydroxyethyl and hydroxypropyl esters of acrylic acid and methacrylic acid, and also amino-group-containing esters and amides of polymerizable acids, such as the dialkylamino esters, for example dimethylamino and diethylamino esters of acrylic acid and methacrylic acid, for example dimethylaminoethyl acrylate or, for example, the corresponding amides, such as dimethylaminopropylacrylamide. Monomers having limited water solubility are used only to the extent that they do not impair the water solubility of the resulting copolymer.

Examples of comonomers suitable for cationic polyacrylamides are cationized esters of (meth)acrylic acid, such as of dimethylaminoethyl (meth)acrylate, diethylaminoethyl (meth)acrylate, diethylaminopropyl (meth)acrylate, dimethylaminopropyl (meth)acrylate, diethylaminopropyl (meth)acrylate, dimethylaminobutyl (meth)acrylate, diethylaminobutyl (meth)acrylate, cationized amides of (meth)acrylic acid, such as of dimethylaminoethyl(meth)acrylamide, diethylaminoethyl(meth)acrylamide, diethylaminopropyl(meth)acrylamide, dimethylaminopropyl(meth)acrylamide, diethylaminopropyl(meth)acrylamide, dimethylaminobutyl(meth)acrylamide, diethylaminobutyl(meth)acrylamide, cationized N-alkylmonoamides and diamides with alkyl moieties containing 1 to 6 C atoms, such as of N-methyl(meth)acrylamide, N,N-dimethylacrylamide, N-ethyl(meth)acrylamide, N-propyl(meth)acrylamide, tert-butyl(meth)acrylamide, cationized N-vinylimidazoles as well as substituted N-vinylimidazoles, such as of N-vinyl-2-methylimidazole, N-vinyl4-methylimidazole, N-vinyl-5-methylimidazole, N- vinyl-2-ethylimidazole and cationized N-vinylimidazolines, such as of vinylimidazoline, N-vinyl-2-methylimidazoline and N-vinyl-2-ethylimidazoline.

The basic monomers are used in neutralized or quaternized form, neutralization being achieved with mineral acids or organic acids and quaternization preferably being achieved with dimethyl sulfate, diethyl sulfate, methyl chloride, ethyl chloride or benzyl chloride. In a preferred embodiment, the monomers quaternized with methyl chloride or benzyl chloride are used.

Preferred comonomers for cationic polyacryamides are the cationized esters and amides of (meth)acrylic acid, each containing one quaternized N atom. Particularly preferably there are used quaternized dimethylaminopropylacrylamide and quaternized dimethylaminoethyl acrylate.

Polymerization of the synthetic water-soluble polymers to be used for the inventive coating is achieved by industrially standard methods, such as gel polymerization, suspension polymerization and emulsion polymerization. Preferred are products from the method of gel polymerization, which is described in German Patent 3544770, for example. The polymer gels obtained by this method are crushed, dried and ground to polymer powders of the desired particle size.

Above and beyond this, however, synthetic water-soluble polymers produced by the method of suspension and emulsion polymerization are advantageously used for the inventive coating.

Preparation of the inventive polymer granules is achieved by bringing the water-soluble polymer powder into contact with the aqueous coating solution of water glass or with the mixture of water glass and a further inorganic or organic water-soluble compound. The particle size of the polymer powder is not critical for the coating operation. From the practical viewpoint, the powders used have different particle-size distributions, depending on the type and use of the water-soluble polymers. As an example, polyacrylamide preferably has the form of a granular product with 90 per cent by mass <2.0 mm, particularly preferably <1.6 mm. For many applications, fine fractions, especially those smaller than 200 μm, are separated from the polymer powder.

The operation of bringing the polymer powder and coating solution into contact is performed with simultaneous intermixing, continuously or in batches; as examples, intermixing is achieved by means of mechanical mixing devices or by means of a fluidized bed. Suitable mechanical mixing machines for application of the coating solution include Patterson-Kelley mixers, DRAIS turbulence mixers, Lödige mixers, Ruberg mixers, screw mixers, disk mixers and fluidized-bed mixers, as well as continuously operating vertical mixers, in which the polymer powder is mixed by means of blades rotating at high frequency (Schugi mixers). Preferably removal of the water entrained by the coating solution is already begun during mixing of the components. For this purpose, heatable mixers and particularly the fluidized-bed method have proven suitable.

For the operation of mixing with the polymer powder, the coating solution is usually adjusted to a concentration range of 1 to 40 wt %, preferably to 2 to 30 wt % and particularly preferably 3 to 10 wt %. Coating solutions with low water-glass concentrations permit the preparation of coatings that are particularly effective for the dissolution operation.

Addition of the coating solution is preferably achieved via spray devices. In cooperation with the mechanical mixing operation or with the fluidized bed, such a technique permits uniform distribution of the solution on the polymer particles.

After the coating solution has been mixed with the polymer particles, drying is carried out, to the extent that it has not already been achieved during the mixing operation. During drying, care is to be taken that the water-soluble polymer particles are not thermally overloaded and damaged. Polyacrylamides are usually dried at temperatures in the range of 50° C. to 150° C., preferably 80° C. to 120° C. The optimal duration of post-heating depends on the water content and the dryer type, but can be easily determined by a few experiments. The heat treatment can be performed in standard dryers or ovens. As examples, there can be cited rotary ovens, fluidized-bed dryers, disk dryers, paddle dryers or infrared dryers.

In a preferred method for synthesizing the inventive polymers, coating with the coating agent is carried out in the fluidized bed. This can be achieved batchwise and continuously.

For this purpose the polymer powder is maintained in suspended condition in a fluidized bed, or in other words in an ascending stream of hot air or inert gas. In this condition the solid particles are separated from one another and thus are accessible all around to the spray droplets while the coating solution is being sprayed into the fluidized bed. Moreover, heat and mass exchange between the solid particles and the gas stream is intensive in this condition. When a suspended particle now encounters a spray droplet, the liquid product of the spray droplet becomes distributed over the surface of the polymer particle by spreading. By virtue of the intensive heat and mass exchange with the surrounding gas stream, the liquid film becomes solidified by drying. Because of multiple spraying, the growing envelope layer on the polymer particles becomes progressively more compact, until a homogeneous closed coating has formed.

The supply-air temperatures in the fluidized-bed apparatus are selected such that, on the one hand, coating accompanied by simultaneous drying is steadily achieved and, on the other hand, the properties profile of the water-soluble polymer does not suffer any impairment due to overheating. The supply-air temperature is usually in the range of 40° C. to 150° C., preferably 60° C. to 110° C., and particularly preferably 70° C. to 90° C. If necessary, deviations from these temperature conditions must be permitted for water-soluble polymers that are particularly sensitive to temperature.

The inventive coating method in which the fluidized bed is used offers the advantage, by virtue of the use of water glass, that the polymer particles can be coated much more homogeneously with a lighter application than is possible with the other mixing methods.

In connection with the fluidized-bed method to be used according to the invention, reference can be made to the pertinent prior art, such as in Ullmann's Encyclopedia of Industrial Chemistry, 5^{th} Edition, Volume B4, pages 239 to 274, and the article of H. Uhlemann, “Continuous fluidized-bed spray granulation”, in Chem.-lng. Tech. 62 (1990), No. 10, pp. 822-834.

In a further embodiment of the inventive method, the water-soluble polymers are coated in the suspended condition, for example in the form of the suspensions, in organic solvents, obtained during suspension polymerization of the water-soluble monomers. In this case, the coating solution is proportioned into the stirred suspension, whereby distribution onto the individual polymer particles takes place. In this operation, the addition of emulsifiers may be necessary for better distribution of the coating solution in the suspension. Removal of water from the polymer particles coated in this way is preferably achieved in the suspended condition by azeotropic distillation. The polymer particles are then separated by filtration and freed from adhering solvent.

In a further embodiment of the invention, emulsions of water-soluble synthetic polymers transformed to powder form after spray drying or drying in the fluidized bed are used and coated with the inventive coating agents in the inventive method.

In a further embodiment of the invention, there are used polymer particles that have already been provided with a layer of the aforesaid further water-soluble inorganic and/or organic compounds. Particularly homogeneous coating of the polymer particles is achieved with the inventive water-glass coating that is then performed.

Because of their excellent dissolution behavior, the inventive coated water-soluble polymers can be used under difficult conditions in many areas of application, including advantageously in water and wastewater treatment, and especially as flocculation auxiliaries in the mining, paper and clarifying-plant industries. Furthermore, the inventive polymers are also very highly suitable for applications in the area of water-soluble thickening and adhesive agents.

### EXAMPLES

Dissolution behavior

The dissolution behavior under difficult conditions was determined as follows: One liter of cold tap water (10 to 15° C.) was placed in a 1-liter glass vessel. Without stirring, 1.0 g of the corresponding polyacrylamide powder was introduced into the dissolution water. After three minutes, the mixture was stirred (300 rpm) with a finger agitator, and the behavior of the product was observed.

The results are evaluated as follows:
poor: Large gelled agglomerates that no longer detach from the bottom are formed.
moderate: The product certainly detaches from the bottom, but forms gelled agglomerates.
good: The product detaches from the bottom and forms only isolated gel agglomerates (at most 5 aggregates).
very good: The product disintegrates completely into the individual particles and does not form any gel agglomerates.

### Example 1

Coating of an anionic polyacrylamide of acrylamide and acrylic acid (Praestol® 2510)*

The Praestol 2510 (total weight of batch including coating was 1500 g in each case) was heated to a product temperature of 60° C. in a Strea 1 Aeromatic laboratory-scale fluidized-bed dryer operating with a supply-air temperature of 100° C. Spraying of the respective solution into the fluidized bed was begun once the product temperature had been reached. A two-component nozzle was used for spraying, and the solutions to be sprayed had a concentration of 5 wt %. During the spraying operation, the product temperature was maintained at 60° C. by an appropriate spraying rate. The coating time to reach 10% coating agent was 56 minutes, and to reach 3% was 24 minutes. At the end of spraying, the nozzle was removed and the air-inlet temperature was lowered to 85° C. At this setting, a product temperature of 75° C. was established for post-drying (30 minutes).

| Coating | Dissolution behavior* |
|---|---|
| 10 wt % sodium sulfate | moderate |
| 10 wt % sodium carbonate | moderate |
| 10 wt % of a mixture of 7 parts of sodium | good |
| carbonate and 3 parts of sodium water | |
| glass (modulus 2) | |
| 3 wt % of sodium water glass (modulus 2) | very good |
| No coating | poor |

*Praestol ® 2510 is a flocculation auxiliary of Degussa AG, dba Stockhausen GmbH & Co. KG

### Example 2

Coating of a cationic polyacrylamide of acrylamide and quaternized dimethylaminopropylacrylamide (Praestaret® PK 422)*

The experiment was performed using the same procedure as in Example 1, except that the product temperature was maintained at 52 to 54° C. during the spraying operation. The coating time to reach 10% coating agent was 56 minutes, and to reach 3% coating agent was 23 minutes and 30 minutes respectively. The solutions to be sprayed had a concentration of 5 wt %.

| Coating | Dissolution behavior* |
|---|---|
| 10 wt % sodium sulfate | moderate |
| 10 wt % of a mixture of 7 parts of sodium | good |
| carbonate and 3 parts of sodium water | |
| glass (modulus 2) | |
| 3 wt % of sodium water glass (modulus 2) | very good |
| 3 wt % of sodium water glass (modulus 2), | very good |
| prolonged spraying time of 30 minutes | |
| No coating | poor |

*Praestaret ® PK 422 is a flocculation auxiliary of Degussa AG, dba Stockhausen GmbH & Co. KG

1. A coated water-soluble polymer, characterized in that the coating contains water glass.

2. A coated water-soluble polymer according to claim 1, characterized in that the water glass has an SiO₂ to MeO₂ modulus of M>1, preferably of M≧2 and particularly preferably of M≧3.

3. A coated water-soluble polymer according to claim 1 and 2, characterized in that the water glass is a sodium water glass.

4. A coated water-soluble polymer according to claim 1 to 3, characterized in that the coating amounts to 0.1 to 25 wt %, preferably 0.5 to 10 wt % and particularly preferably 1 to 5 wt % of the coated polymer.

5. A coated water-soluble polymer according to claim 1 to 4, characterized in that the coating contains a further inorganic and/or organic water-soluble salt.

6. A coated water-soluble polymer according to claim 5, characterized in that the further inorganic and/or organic water-soluble salt is disposed in a separate layer underneath the outer, water-glass-containing layer.

7. A coated water-soluble polymer according to claim 5 and 6, characterized in that the further inorganic and/or organic water-soluble salt is selected from the group of alkali metal salts comprising the carbonates, sulfates, halides, mono-, di- and triphosphates, borates, phosphonates, carboxylates, nitrates, sulfonates, acetates, hydroxycarboxylic acids and amino acids and its proportion in the coating amounts to 1 to 99 wt %, preferably 2 to 70 wt % and particularly preferably 5 to 50 wt %.

8. A coated water-soluble polymer according to claim 1 to 7, characterized in that it is treated with an anti-blocking agent.

9. A coated water-soluble polymer according to claim 1 to 8, characterized in that the water-soluble polymer is a homopolymer or copolymer of acrylamide.

10. A coated water-soluble polymer according to claim 9, characterized in that the copolymer is anionic.

11. A coated water-soluble polymer according to claim 10, characterized in that it was synthesized using acrylic acid, vinylsulfonic acid, acrylamidomethylpropanesulfonic acid and/or salts thereof.

12. A coated water-soluble polymer according to claim 9, characterized in that the copolymer is cationic.

13. A coated water-soluble polymer according to claim 12, characterized in that it was synthesized using cationized esters or amides of (meth)acrylic acid, each containing one quaternized N atom, preferably quaternized dimethylaminopropylacrylamide and quaternized dimethylaminoethyl acrylate.

14. A coated water-soluble polymer according to claim 1 to 8, characterized in that the water-soluble polymer is a modified polysaccharide.

15. A method for synthesizing the polymers according to claim 1 to 14, characterized in that the water-soluble polymer is coated while being intermixed with an aqueous solution of the coating agent and coating is performed several times if necessary.

16. A method according to claim 15, characterized in that the aqueous solution of the coating agent has a concentration of 1 to 40 wt %, preferably to 2 to 30 wt % and particularly preferably 3 to 10 wt %.

17. A method according to claim 15 and 16, characterized in that intermixing is achieved at elevated temperature and water is evaporated simultaneously.

18. A method according to claim 15 to 17, characterized in that intermixing is achieved in a fluidized bed.

19. A method according to claim 15 to 18, characterized in that the supply-air temperature in the fluidized bed is in the range of 40° C. to 150° C., preferably 60° C. to 110° C., and particularly preferably 70° C. to 90° C.

20. The use of the polymers according to claim 1 to 14 for water treatment, especially as flocculation agents in waters of the paper industry, of the mining industry and of the clarifying-plant industry.

21. The use of the polymers according to claim 1 to 14 as thickening agents and adhesive agents.
